(19) United States
(12) Patent Application Publication
(10) Pub. No.: US 2010/0065487 A1
(43) Pub. Date: Mar. 18, 2010

(54) BLOCK TYPE MEMBRANE MODULE FRAME

(76) Inventor: Jae-Young Jang, Seoul (KR)

Correspondence Address: BIRCH STEWART KOLASCH & BIRCH, PO BOX 747, FALLS CHURCH, VA, 22040-0747, US

(21) Appl. No.: 12/440,582

(22) PCT Filed: May 17, 2007
(86) PCT No.: PCT/KR07/02410

§ 371 Date: Mar. 9, 2009

(30) Foreign Application Priority Data
Nov. 6, 2006 (KR) 10-2006-0108962

(51) Int. Cl. B01D 63/08

(52) U.S. Cl. 210/233

(57) ABSTRACT

A block type membrane module frame is disclosed, in which a plurality of membrane modules form one membrane module block, and a plurality of the membrane module blocks are engaged with each other using a frame for thereby manufacturing a block type module frame, so that a contaminated and waste water treatment module can be easily manufactured depending on a capacity of a treatment tank.

### TECHNICAL FIELD

The present invention relates to a membrane module for a water treatment, and in particular to a block type membrane module frame in which a plurality of membrane modules form one membrane module block, and a plurality of membrane module blocks are engaged with each other via a frame for thereby forming a block type module block frame, so that a contaminated and waste water treatment module can be easily manufactured depending on the capacity of a water treatment tank.

### BACKGROUND ART

Generally, life waste water discharged from home, industrial waste water and livestock waste water may cause serious water pollution problems. In recent years, as many people have big concerns on an environment problem, a proper treatment of the above waste water is very important. So, various contaminated and waste water treatment methods are developed.

As a treatment method of contaminated and waste water, a contaminated water intense treatment method is developed in combination with biological, physical and chemical methods. In the above intense treatment method, organic substances are first decomposed using microorganism, and nitrogen compound and phosphoric compound are removed for thereby purifying contaminated water. Here, a water treatment membrane module and a water treatment membrane module structure using the same are generally adapted for a water treatment process.

The conventional water treatment membrane module is installed at an upper side of an aeration tank of a common water treatment apparatus and comprises a rectangular support plate having a fluid flow path formed on its surface, a separation film which is attached on a surface of the support plate and filters foreign substances from flowing liquid, and a discharge port which is provided at one side end of a rim of the support plate and discharges the fluid passed via the flow path to the outside using a pump.

When a discharge pump operates, a solid substance having a certain size such as sludge in contaminated water does not flow into the interior of the separation film, but the liquid passes through the separation film and flows into the path of the support plate. The liquid is discharged to the outside via the path formed in the support plate and the discharge port connected with the flow path, so that contaminated water is purified.

The above membrane module is generally installed at the aeration tank. In this case, the membrane module is supported by means of the support frame of the aeration tank. The membrane modules are arranged in a straight line with the help of interval maintaining members formed at the support frame.

According to the membrane module arranged with the help of the interval maintaining members, the foreign substances attached on the surface of the separation film are separated in the course of the aeration at the lower side of the same for thereby enhancing a sludge absorption efficiency of the separation film.

In the case that the membrane modules are arranged on the upper side of the aeration tank, since they are installed using the interval maintaining members, it is not easy to install the same.

In the case that a large capacity of the aeration tank is needed, since more membrane modules should be installed, the workability of workers decreases, so that the cost increases.

### DISCLOSURE OF INVENTION

### Technical Problem

Accordingly, it is an object of the present invention to provide a block type membrane module frame which overcomes the above-mentioned problems.

It is another object of the present invention to provide a block type membrane module frame which can be adapted depending on a treatment capacity of contaminated and waste water by manufacturing a membrane module in a block type.

It is further another object of the present invention to provide a block type membrane module frame in which a plurality of membrane modules form one membrane module block, and a plurality of the membrane module blocks are engaged with each other using a frame for thereby manufacturing a block type module frame, so that a contaminated and waste water treatment module can be easily manufactured depending on a capacity of a treatment tank.

### Technical Solution

To achieve the above objects, in a membrane module for a contaminated and waste water treatment which includes a support plate having a fluid flow path on its surface, a separation film which is attached on a surface of the support plate for filtering a foreign substance from passing liquid, and a discharge port which is provided at a rim of the support plate for discharging liquid passed through the path to the outside in the course of pumping operation, there is provided a block type membrane module frame which comprises a plurality of module blocks which are symmetrically provided in a pair, and a plurality of slits are formed at the corresponding surfaces of the same, with both ends of the membrane modules being inserted into the slits, with the module blocks being exposed to the outside via engaging grooves having discharge ports in a state that both ends of the membrane module are inserted into the slits, with an accommodation groove being formed at both outer sides for accommodating the discharge ports, with the module blocks being provided with a cover body formed at an outer surface and having one suction port communicating with the discharge ports.

The module blocks, in which a pair of module blocks used for fixing the membrane modules are provided in left and right sides or upper and lower sides, are fixedly engaged with each other using a frame.

A plurality of pin engaging members are symmetrically protruded from both ends of the membrane modules, and guide parts having guide grooves are outwardly protruded from the surfaces of the slits of the module blocks so that the pin engaging members are arranged, and the pin engaging member inserted into the guide groove is fixed using the pin provided at an outer side of the guide part.

The discharge ports are symmetrically formed at both ends of the membrane module in pairs.

### Advantageous Effects

In the block type membrane module frame according to the present invention, the membrane modules are manufactured in a block type, so that it is possible to design and adapt the present invention depending on the treatment capacity of contaminated water.

In other words, a plurality of membrane modules form one membrane module block, and the membrane module blocks are engaged with each other using a frame for thereby forming a block type module block frame. So, it is easy to manufacture a contaminated water treatment module depending on the capacity of treatment tank.

Since the block type module modules are arranged and fixed in left and right sides or upper and lower sides using a frame, it is possible to maximize the capacity of treatment tank.

In the present invention, when the blocks need a repair or exchange owing to a partial damage, only a corresponding block is exchanged, so that the maintenance and repair work are so easy.

### BRIEF DESCRIPTION OF THE DRAWINGS

FIG. 1 is a perspective view illustrating an engaged state of a block type membrane module frame according to the present invention.

FIG. 2 is a disassembled perspective view of FIG. 1.

FIG. 3 is a perspective view illustrating an engaged state of a membrane module of FIG. 2 and a pin.

FIG. 4 is a perspective view illustrating an engaged state that a cover body is engaged to a module block of FIG. 2.

FIG. 5 is a front view illustrating an adaptation state of a block type membrane module frame according to the present invention.

### BEST MODE FOR CARRYING OUT THE INVENTION

According to the present invention, in a membrane module 120 for a contaminated and waste water treatment which includes a support plate 121 having a fluid flow path on its surface, a separation film 122 which is attached on a surface of the support plate 121 for filtering a foreign substance from passing liquid, and a discharge port 123 which is provided at a rim of the support plate 121 for discharging liquid passed through the path to the outside in the course of pumping operation, there is provided a block type membrane module frame which comprises a plurality of module blocks 140 and 140a which are symmetrically provided in a pair, and a plurality of slits 142 are formed at the corresponding surfaces of the same, with both ends of the membrane modules 120 being inserted into the slits 142, with the module blocks being exposed to the outside via engaging grooves 144 having discharge ports 123 in a state that both ends of the membrane module 120 are inserted into the slits 142, with an accommodation groove 186 being formed at both outer sides for accommodating the discharge ports 123, with the module blocks being provided with a cover body 180 formed at an outer surface and having one suction port 184 communicating with the discharge ports 123.

### MODE FOR THE INVENTION

The preferred embodiments of a block type membrane module frame according to the present invention will be described with reference to the accompanying drawings.

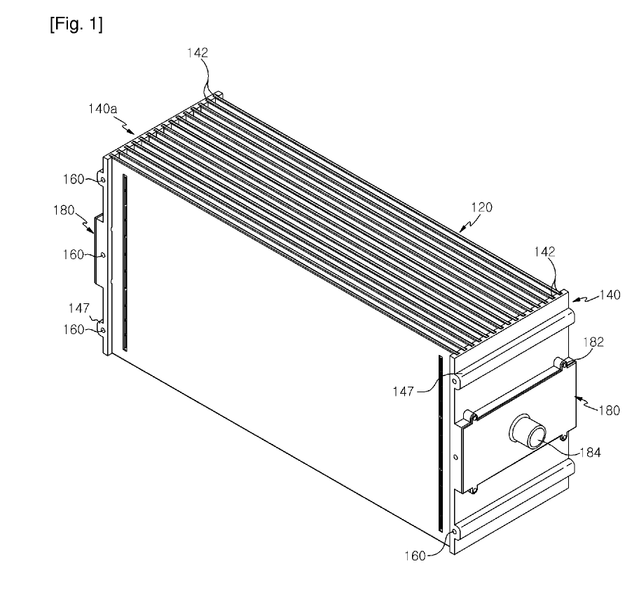

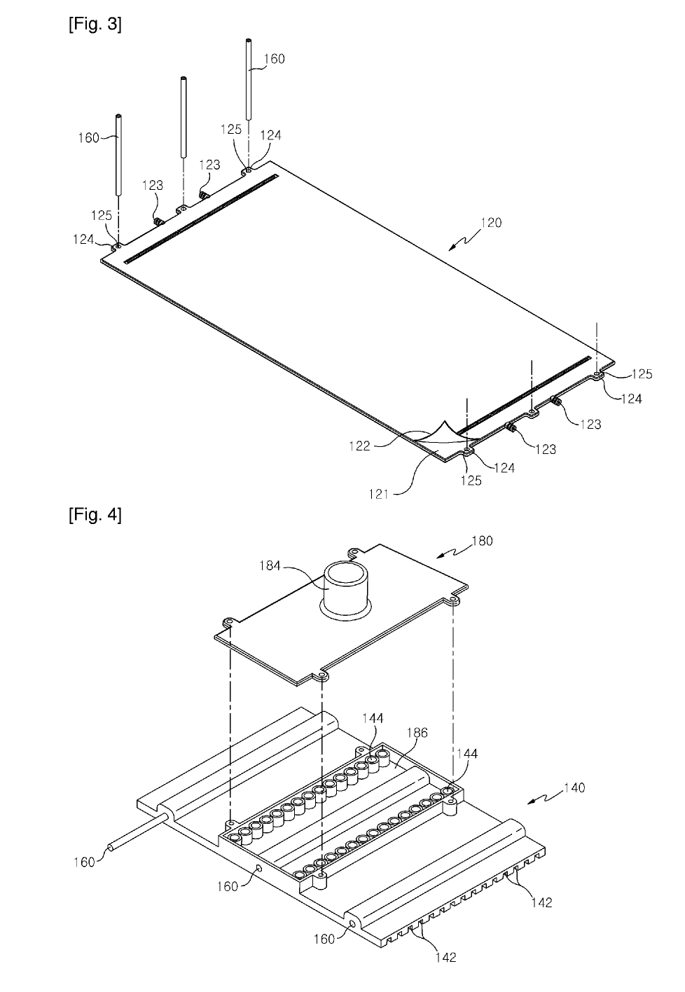

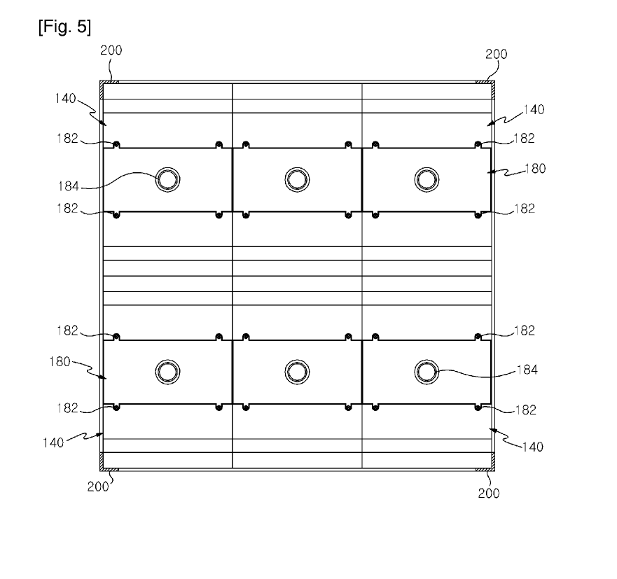

As shown in FIGS. 1 through 4, the present invention is adapted to a contaminated and waste treatment tank and comprises a membrane module 120 for filtering foreign substances from contaminated water and discharging the same, a pair of module blocks 140 and 140a symmetrically arranged so that a plurality of membrane modules 120 are arranged, and a frame 200 which fixes the module blocks 140 and 140a provided for fixing the membrane modules 120.

The membrane module 120 comprises a rectangular support plate 121 having a fluid flow path formed on its surface, a separation film 122 which is attached on a surface of the support plate 121 for filtering foreign substances from the liquid, and at least one discharge port 123 which are provided at both ends of a rim of the support plate 121 and discharges toe fluid to the outside.

The discharge port 123 performs the same functions as described in the conventional art and discharges to the outside the fluid passed through the separation film 122 among the contaminated water of the treatment tank in the course of pumping. The discharge ports 123 are symmetrically installed at both ends of the membrane module 120 in pairs.

Pin engagement members 124 are protruded from both ends of the membrane module 120, with the pin holes 125 being formed at an intermediate portion, and both ends distanced from the intermediate portion, respectively.

Here, the pin engagement member 124 allows a plurality of membrane modules 120 to be arranged on the module blocks 140 and 140a.

The module blocks 140 and 140a, which are key elements of the present invention, are symmetrically provided in a pair, and the membrane modules 120 are arranged and fixed at the corresponding surfaces of the same.

In the module blocks 140 and 140a, a plurality of slits 142 are arranged and fixed in protruded shapes so that the ends of the membrane modules 120 are fixedly inserted into the corresponding surfaces of the same. Engaging holes 144 are formed on the surfaces of the slits 142 so that the discharge ports 123 protruded from the ends of the membrane modules 120 pass through the same. Guide parts 147 having guide grooves 146 are outwardly protruded so that a plurality of pin engaging members 124 are inserted.

The numbers of the slits 142 are determined so that about 10˜15 membrane modules 120 are arranged.

Pin holes 148 are formed at the outer sides of the guide parts 147 in the same axial direction as the pin hole 1w25 of the pin engaging member 124.

As the end of the membrane module 120 is inserted into the slit 142, the pin engaging member 124 is arranged in the guide groove 146. As the pin 160 is pushed into the pin hole 148 from the outer side of the guide part 147, the pin 160 passes through the pin hole 125 of the pin engaging member 124 for thereby integrally fixing a plurality of membrane modules 120.

The discharge ports 123 are exposed from the outer surfaces of the module blocks 140 and 140a to the outside via the engaging holes 144. The exposed discharge ports 123 are covered by a cover body 180 having an accommodation groove 186 and are fixedly sealed using bolts 182. One suction port 184 is formed at an outer side of the cover body 180. The suction port 184 is connected with the discharge port 123 via the accommodation groove 186.

A pumping unit is connected with the suction port 184. As a pumping operation is performed, treatment water is discharged from the discharge port 123 to the outside via the accommodation groove 186 and one suction port 184.

According to another embodiment of the present invention, a pair of module blocks 140 and 140a, which are adapted to fix the membrane module 120, are arranged in multiple pairs at the left and right sides or upper and lower sides, respectively. The module blocks are preferably engaged with each other using frames 200.

The above construction is well adapted when the capacity of the treatment tank is large. The module blocks may be designed and manufactured depending on the capacity of the treatment tank using the frames and may be engaged to the treatment tank.

The assembling and installation procedures of the block type membrane module frame according to the present invention will be described with reference to the accompanying drawings.

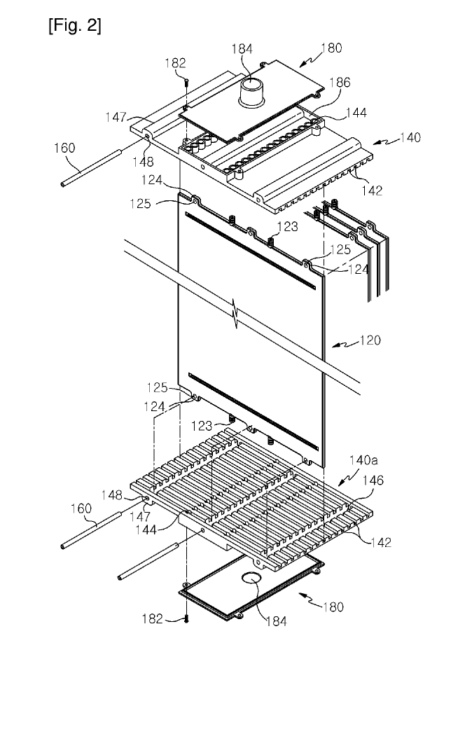

First, as shown in FIG. 1 or 2, a plurality of membrane modules 120 are prepared by attaching the separation films 122 to the support plates 121. The membrane modules 120 are arranged and fixed in the slits 140 formed at the corresponding surfaces of the module blocks 140 and 140a. The discharge ports 123 of the membrane modules 120 are exposed to the outside via the engaging holes 144 formed on the surfaces of the slits 142, and the pin engaging members 124 are positioned in the guide grooves 146 of the slits 142, and the pins 160 are inserted into the pin holes 148 formed in the guide parts 147. The pins 160 sequentially pass through the pin holes 125 of the pin engaging members 124 for thereby fixing a plurality of membrane modules 120. The cover body 180 is allowed to closely contact with the outer sides of the module blocks 140 and 140a and is engaged using the bolt 182, so that the accommodation groove 186 of the cover body 180 accommodates the discharge ports 123 exposed to the outsides of the module blocks 140 and 140a, and the discharge ports 123 communicate with one suction port 184 formed at the cover body 180. So, one block type membrane module is manufactured.

As shown in FIG. 5, in case that the capacity of the treatment tank is large, a plurality of the block type membrane modules are arranged in upper and lower sides or left and right sides and are engaged with each other using the frame 200 depending on the capacity of the treatment tank for thereby manufacturing a block type membrane module frame.

When the present invention is assembled and installed in the treatment tank, it is preferably installed on the upper side of the aeration tank. In the course of operation, a tube connected with the pumping unit is fixed at the suction port 184, and the pumping operation is performed. So, the treatment water passed through the discharge port 123 is discharged to the outside via one suction port 184 via the accommodation groove 186.

### INDUSTRIAL APPLICABILITY

As described above, in the block type membrane module frame according to the present invention, the membrane modules are manufactured in a block type, so that it is possible to design and adapt the present invention depending on the treatment capacity of contaminated water.

In other words, a plurality of membrane modules form one membrane module block, and the membrane module blocks are engaged with each other using a frame for thereby forming a block type module block frame. So, it is easy to manufacture a contaminated water treatment module depending on the capacity of treatment tank.

Since the block type module modules are arranged and fixed in left and right sides or upper and lower sides using a frame, it is possible to maximize the capacity of treatment tank.

In the present invention, when the blocks need a repair or exchange owing to a partial damage, only a corresponding block is exchanged, so that the maintenance and repair work are so easy.

1. In a membrane module 120 for a contaminated and waste water treatment which includes a support plate 121 having a fluid flow path on its surface, a separation film 122 which is attached on a surface of the support plate 121 for filtering a foreign substance from passing liquid, and a discharge port 123 which is provided at a rim of the support plate 121 for discharging liquid passed through the path to the outside in the course of pumping operation, a block type membrane module frame, comprising:
a plurality of module blocks 140 and 140a which are symmetrically provided in a pair, and a plurality of slits 142 are formed at the corresponding surfaces of the same, with both ends of the membrane modules 120 being inserted into the slits 142, with the module blocks being exposed to the outside via engaging grooves 144 having discharge ports 123 in a state that both ends of the membrane module 120 are inserted into the slits 142, with an accommodation groove 186 being formed at both outer sides for accommodating the discharge ports 123, with the module blocks being provided with a cover body 180 formed at an outer surface and having one suction port 184 communicating with the discharge ports 123.

2. The frame of claim 1, wherein said module blocks, in which a pair of module blocks 140 and 140a used for fixing the membrane modules 120 are provided in left and right sides or upper and lower sides, are fixedly engaged with each other using a frame 200.

3. The frame of either claim 1 or claim 2, wherein a plurality of pin engaging members 124 are symmetrically protruded from both ends of the membrane modules 120, and guide parts 147 having guide grooves 146 are outwardly protruded from the surfaces of the slits 142 of the module blocks 140 and 140a so that the pin engaging members 125 are arranged, and the pin engaging member 124 inserted into the guide groove 146 is fixed using the pin 160 provided at an outer side of the guide part 147.

4. The frame of claim 1, wherein said discharge ports 123 are symmetrically formed at both ends of the membrane module 120 in pairs.
